(19) United States
(12) Patent Application Publication
(10) Pub. No.: US 2004/0181988 A1
(43) Pub. Date: Sep. 23, 2004

(54) Base sign with integral signage and method for its fabrication

(75) Inventor: Larry G. Ingraham, Fostoria, OH (US)

Correspondence Address: RUDEN, MCCLOSKY, SMITH, SCHUSTER & RUSSELL, P.A., P.O. BOX 1900, FORT LAUDERDALE, FL, 33301, US

(73) Assignee: Roppe Corp., Fostoria, OH

(21) Appl. No.: 10/815,382

(22) Filed: Apr. 1, 2004

Related U.S. Application Data
(63) Continuation of application No. 09/876,516, filed on Jun. 7, 2001.
(60) Provisional application No. 60/210,650, filed on Jun. 9, 2000.

(51) Int. Cl. G09F 3/10

(52) U.S. Cl. 40/671; 40/584

(57) ABSTRACT

A sign is formed from an indicia donor element and an indicia recipient base element. The recipient base has a first color; and signage indicia is removed therefrom to cause the recipient element to be stencil-like. The donor element has a second color; and signage indicia is removed therefrom and installed into the stencil-like openings in the recipient element, to form the sign having one color of background and a second color of signage integral therein. Preferably, the donor and recipient elements are of the same baseboard material, except for color; and the donor signage is snap fit into the recipient base. The preferred orientation for this sign is vertical, just above floor level. Visual recognition of the signage can be enhanced by phosphorescence or glitter treatment. Tactile signage sensing can be enabled by texture difference between donor and recipient materials.

### CROSS-REFERENCES TO RELATED APPLICATIONS

This application claims the benefit of U.S. Provisional Application No. 60/210,650, filed on Jun. 9, 2001, entitled BASEBOARD WITH INTEGRAL SIGN AND METHOD FOR ITS FABRICATION.

### BACKGROUND OF THE INVENTION

1. Field of the Invention

This invention concerns, in a preferred embodiment, safety signs used in the interior of buildings.

2. Prior Art

The need for safety signs and their use inside of buildings is well recognized and well known. Signs: painted on walls; mounted above exits, with or without flashing/continuous lighting; pointing to exits, fire escapes, etc.; held by screwed-on frames; adhesive backed; luminescent; are in common use and often are mandated by building codes. For the most part, such signs are attachments to existing walls, doors and stairways and are not provided and mounted until the building has been finished, or nearly so. Also, such signs are not “convenient” with respect to cleaning and repainting of the walls, doors, etc., to which these signs are mounted. Some of the prior art safety signs are difficult to read when certain unsafe conditions are present, such as smoke.

### SUMMARY OF THE INVENTION

The present invention overcomes many of the problems of prior art signs, signage and especially safety signs used on the interior of buildings. This invention's unique sign is formed in a conventional base or carpet cove i.e. “base”; and thus is of rugged and easily cleanable material, such as rubber and vinyl plastic. This sign can be installed while the adjacent parts of the building are being finished; i.e., at the same time that regular bases/carpet coving is being installed and in the same manner of installation; hence, no special installation equipment nor specially trained labor is required. Sign symbols and words i.e. signage (indicia) are of the same material as the base, but of a different color and/or texture and/or appearance. This is accomplished by forming the signage/indicia information from a donor piece of the base material and inserting it permanently into corresponding indicia cutouts in a recipient base, having a difference of at least one of color, texture, appearance than the donor piece. The cutting of the signage information can be by various means., including water jet cutting and die cut. By placing the safety sign just above floor level, it is best seen by people crawling along in smoky hallways, etc.

### BRIEF DESCRIPTION OF THE FIGURES

FIG. 1 is a perspective view of a first piece of conventional base of the cove type, the recipient base element;

FIG. 2 is a front view of the base element of FIG. 1, having indicia cutouts, most of which having been removed;

FIG. 3 is a front view of a second piece of base material, the donor element, having a different color than the first, recipient base of FIGS. 1 and 2;

FIG. 4 is a front view of FIG. 3, showing signage indicia cutouts, with most of the indicia removed;

FIG. 5 is a front view of various indicia; and

FIG. 6 is a perspective view of the assembled safety sign of this invention, having the recipient base of FIG. 2 and the signage indicia from the donor base of FIG. 4, mounted to the bottom of a wall.

### DESCRIPTION OF THE PREFERRED EMBODIMENT

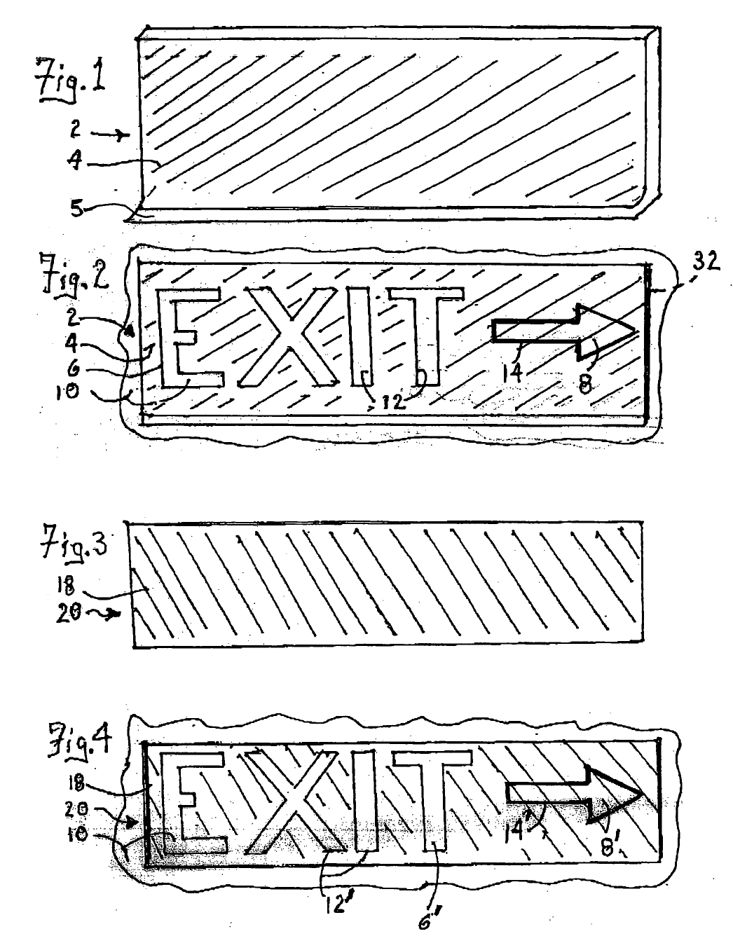

The primary/preferred embodiment of this invention is a safety sign for the interior of a building. This safety sign comprises a recipient base, with the signage information/indicia being integrated within and surrounded by the recipient base; but the signage originates from a different piece of base material, the donor element. The finished sign product is shown in FIG. 6; and the different materials employed, along with the progressive method of fabrication, are shown in FIGS. 1-5.

FIG. 1 shows in perspective a standard piece 2 of base. The term “base”, as employed hereinafter, encompasses other similar items, such as: carpet coving, cove base, stair riser, carpet cove cap, wall base, cove wall base, etc., as are well known in the building, flooring and carpeting trades. As also well known, the base is to be secured to the bottom few inches of a wall and overlies a small edge portion of the flooring, so as to cover the gap between the wall and flooring and protect the bottom of the wall from being scuffed. The baseboard 2 also can be employed as a stair riser.

Baseboard often is delivered to the job site in selected lengths of two to eight feet, as well as in rolls of greater length. Typical materials for bases have been rubber and plastic. ASTM Standard F-1861 identifies three acceptable materials, to meet safety requirements: Thermoset Vulcanized SBR Rubber (TS); Thermoplastic Rubber (TP); and Thermoplastic Vinyl (TV). The baseboard 2 in FIG. 1 preferably is of any one of the ASTM-accepted materials, such as extruded type TS and would have any one of many colors, such as tan 4, (a first color) that would be compatible with the decor of the wall/floor/stair area in which the sign is to be installed. The color 4 is shown by upward right shading of the same type in FIGS. 1, 2 and 6. A very good quality of base material for the recipient element 2 would be ⅛″ (3.175 mm) thick, but could be thinner, such as 0.080″ (2.03 mm). To enable the safety sign resulting from the base 2 with integral indicia signage to be able to wrap around posts, corners, etc., it should meet the flexibility of ASTM F-137. The base material also should meet fire codes as well as be easily washable. To be easy to install with standard adhesives and for long lasting adhesion, the backside of the base 2 can be ribbed, as is well known. Although the base in FIG. 1 is shown with a standard toe 5, it could be provided with other toes, or no toe. The running length of the finished safety sign could be any convenient length, or a little longer than the signage length, or some increment lengths such as two, four or six feet. Likewise the height of the base 2 could be anything, but would be better to conform to industry standards, such as 2½ (63.5 mm), 4″ (101.6 mm) and 6″ (152.0 mm). The surface of the base element 2 suitably can be of a low-gloss satin finish, which would be easy to clean with soap and water as well as other typical industrial cleaners used inside buildings for flooring and baseboards.

With reference to FIG. 2, a front view of the base 2, take as an example that the safety sign finished product (shown only in FIG. 6) is to have the signage indicia “EXIT” 6, with an arrowhead 8 pointing to the right. Accordingly, as first steps in the fabrication of the sign according to this invention, there would be: a selection of base 2 material, color 4 and content of signage indicia 6, 8. Then, a suitable length of recipient base 2 of tan color 4 is obtained. Next, as shown in FIG. 2, the indicia 6, 8 are to be cutout from the base 2, preferably by cutting completely through the thickness of the base as if making a stencil. The method and equipment for such cutting can be determined by the fabricator; however, die cut and water jet cutting are useful. For ease of viewing and understanding FIG. 2, and not part of the fabrication, assume that the base 2 is lying on a workbench having a top surface of color 10, such as white, in color contrast to the tan 4 of the base. Also assume that the EXIT indicia 6 has been cut out and fully removed from the base. Thus, there remains the hollow shapes 12, stencil-like, of the letters of EXIT, surrounded by the tan colored 4 material of the donor base 2. Also assume that the arrowhead 8 has been cut, around the line 14, but not yet removed. Once the arrowhead 8 is removed, the recipient base 2 will be ready for final assembly into the safety sign product 16, shown in FIG. 6. As will be understood, the recipient base 2 defines the background, the support and the framework for the signage.

The next step of fabrication is to select one or more colors for the indicia of the sign 16. For simplicity, let us select dark green (slant to the upper left shadings in FIGS. 3 and 6) for all of the indicia 6′ and 8′, the letters of the word EXIT and the arrowhead, as they will appear in the sign 16. To obtain donor material for the dark green 18 (the second color) indicia 6′, 8′, a piece of base material 20 of dark green 18, as shown in FIG. 3, is chosen. The material 20 preferably would be the same thickness and substance as the base 2, but does not have to be a piece of toed base; it can be flat, not coved, and narrower (less height) than the base 2. However, its height has to be at least that of the tallest portion of the indicia 6′, 8′, which in the present example is the letter E.

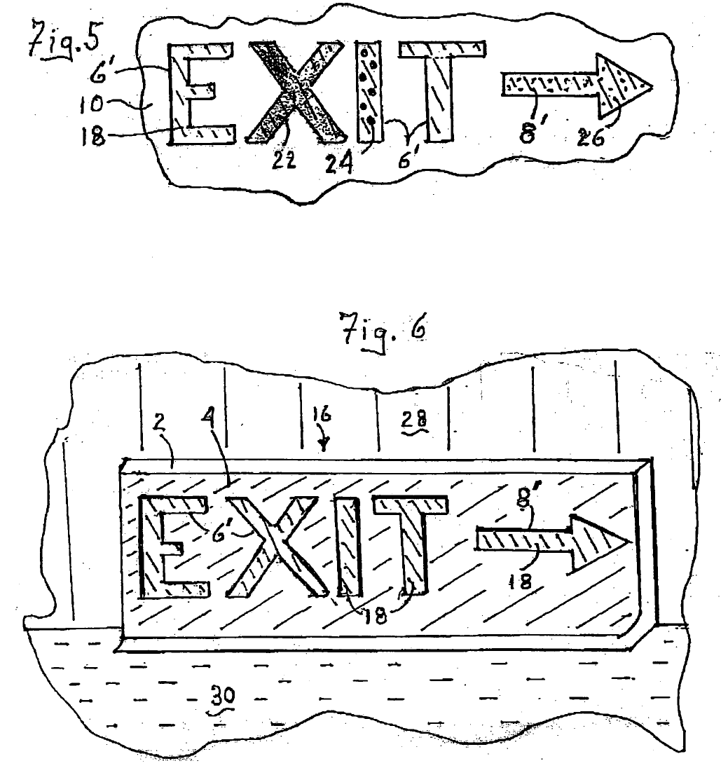

For the same reasons as discussed with respect to FIG. 2, assume that in FIG. 4: the dark green piece of material 20 is lying on the white top 10 of a workbench; the EXIT indicia 6′ has been cut out and removed, leaving the white top 10 visible below the hollow, stencil-like letter shapes 12′; and the arrowhead 8′ has been cut around the line 14′, but not yet removed. If the cutting process, which makes the cut line 14 and similar cut lines around the EXIT indicia 6, removed essentially none of the recipient base 2, then the indicia 6′ and 8′ cut from the donor material 20 could be the same size as the indicia 6 and 8; however, that is not to be expected for most cutting processes. Hence, the indicia 6′, 8′ from the donor material 20 will have to be slightly larger than the indicia 6, 8 removed from the base 2, so as to fit snugly into the hollow shapes 12 of the indicia in the recipient base 2. Such a snug fit also can be termed a snap-in fit, but need not be so tight as a force fit, requiring machine pressure insertion. In FIGS. 2, 4-6, the size differences between the indicia 6 and 6′, and 8 and 8′ and the hollow shapes 12 and 12′ are not easily seen, because of the scale of these Figs.

FIG. 5 shows the green colored indicia 6′, 8′ lying on the workbench top 10, after cutout and removal from the donor material 20. Although the indicia 6′, 8′ now are ready to be inserted, for example manually, into the base 2 and, in the present example will be seen as dark green 18 on a tan 4 background, it could be advantageous to increase their visual recognition in the event of hazy/smoky conditions or dim lighting. The indicia surfaces could be coated/impregnated, either before or after being cut out, with phosphorescent substance (escape routing photo-luminescent, per D.I.N. 67510), glitter particles, etc., as symbolized by the references 22, 24 in FIG. 5. The entire surface of the donor material 20 could thus be enhanced. Another recognition enhancement would be tactile by providing the surface of the indicia 6′, 8′ with a texture significantly different from the texture of the surrounding surface of the recipient base 2. For example, a rough surface 26, also shown in FIG. 5.

Once the signage indicia 6′, 8′ are ready, as in FIG. 5, they are inserted snugly into their respective, recipient cutout shapes 12 in the base 2; and the resulting product 16 can be packed and shipped for use in a building site, to be installed as shown in FIG. 6, against the bottom of a wall 28 and over the top edge of flooring 30. The installing would be the same as for standard base, for example mastic troweled onto the wall 28 behind the position of the safety sign 16, which then is placed into firm surface contact with the wall. Such mastic or other installing means also would secure the indicia 6′, 8′ in their positions. Not shown in FIG. 6 are pieces of baseboards which normally would be positioned to the left and right of the sign 16, in the typical installation of the baseboard.

Since the steps of packing, shipping, unpacking and handling the sign product 16 might dislodge the indicia 6′, 8′ from their positions in the base 2, the backside of the base 2 could be provided with a peel off, sticky backing 32′ (shown with a phantom reference line in FIG. 2) after the indicia 6, 8 are removed. Thereupon, when the indicia 6′, 8′ are inserted into the base 2, they will adhere to the sticky side of the backing 32 until it is removed, just prior to mounting the entire sign product 16 against the wall 28.

Although it is believed preferable for the front surfaces of the base 2 and the indicia 6′, 8′ to lie in a common plane, for ease of periodic cleaning the sign product 16 subsequent to its installation, and that is why the base 2 and the second piece of base material 20 would be of the same thickness; there could be circumstances, for example tactile recognition, where it was desired for the indicia 6′, 8′ to be inset (thinner than) or projecting forward from (thicker than) the front surface of the base stencil, support 2, which would require that the donor base material 20 also be respectively thinner or thicker than the base 2.

Although the preferred example shown in FIGS. 1-6 employs only two pieces of base material 2 and 20 to attain a background color (tan 4) of the recipient (first) base element and an indicia color (green 18), from the second base element, the donor, more pieces of donor base can be employed to achieve more than one color of signage. Also, each component of the signage, the individual letters and the arrow of FIGS. 4-6, for example, need not be cut out to be separate from each other. Some or all donor portions can be linked to each other, as in a script font. Likewise then, the stencil-like cutting out and removal from the first base member 2, the recipient, of the indicia need not be one component separate from the next.

The sign of this invention and the method of its fabrication will be understood to be advantageous over signs made of a similar base or baseboard material upon which the signage merely is inked or painted upon, or a signage sheet is glued on top of, or the signage is laminated upon.

The term “safety sign” has been used hereinabove to emphasize the preferred content of the signage. However, the word “safety” could be replaced by the word “information” or be omitted. Likewise, the preferred—just above the floor level—location of this sign of this invention should not be its only place of use. As mentioned hereinabove, the sign could be positioned on a stair riser. Indeed, other placements of the unique sign of this invention are well within the skill of the building and interior finishing trades, to accomplish signage needs.

That which is considered within the ambit of my invention is set forth in the next following claims

In the claims:

1. A method for fabricating a sign, comprising the steps of:
selecting three dimensional pieces of element material for defining respectively a signage recipient base element and at least one signage donor element; said pieces of element material being of similar substance construction, except for at least one difference in appearance or tactile perception;
determining signage content for said sign;
removing from said recipient base element specific substance configured to represent said signage content, such that there remains as said recipient base element a stencil-like base possessing said signage content;
extracting from said signage donor element signage material configured substantially the same as said signage content specific substance of said recipient base element; and
inserting into said stencil-like base recipient element said signage material from said donor element, to thereby fillin said stencil-like base.

2. The method according to claim 1 in which said step of extracting includes;
cutting from said donor element three dimensional material.

3. The method according to claim 1 in which steps of removing and extracting are accomplished by at least one of die cutting and water jet cutting.

4. The method according to claim 1 in which said inserting causes said signage material to be integral within said recipient base element.

5. The method according to claim 4 in which said inserting is by snap-fit.

6. The method according to claim 1 in which one of said pieces having a color different than said other piece; whereby said signage has a color different from said recipient base color.

7. The method according to claim 1 in which said selecting is of three said pieces, each said piece having a difference of color; whereby said signage is of two colors, both different from the color of said recipient base.

8. The method according to claim 1 in which said difference is of tactile perception and is accomplished by;
employing as said signage donor element a material having a surface texture significantly different from the recipient element.

9. The method according to claim 1 in which said difference is one of tactile perception, which is accomplished by;
causing said signage material to have a thickness dimension significantly different than the thickness dimension of said recipient base element; whereby said signage is inset or projects from said recipient base.

10. The method according to claim 1 in which said step of determining signage content defines safety signage; and
said step of selecting pieces of element material includes selecting for said recipient base material conventional baseboard product; whereby said sign will be Suitable for installing as a section of baseboard within a building.

11. The method according to claim 1 further comprising, after said step of removing, the step of;
affixing a sticky backing to said recipient base element for the temporary adherence of said signage material in said recipient base element, until said sign is ready for installation.

12. A sign comprising:
a three dimensioned element which, defines a signage recipient base element,
at least one signage donor element having three dimensions;
said base and donor elements being constructed of similar substance, except for at least one difference in appearance or tactile perception;
said base element containing a stencil-like portion, which is configured to support therein signage material from said signage donor element; and
three dimensional signage material, from said donor element, inserted into said stencil-like portion of said base element.

13. A sign according to claim 12 in which,
said donor element signage material comprises a plurality of sub-parts; and
said stencil-like portion comprises a plurality of separate sub-portions, with each said sub-portion having inserted therein at least one of said plurality of donor element sub-parts.

14. A sign according to claim 13 in which some of said sub-parts are of different colors.

15. A sign according to claim 14 in which said recipient base element has a color contrasting from said different colors of said sub-parts.

16. A sign according to claim 12 in which said one difference is color.

17. A sign according to claim 12 in which said one difference is texture.

18. A sign according to claim 12 in which said one difference is in the thickness dimension.

19. A sign according to claim 12 in which said signage material is inserted by virtue of snap-fit to become integral within said base element.

20. A sign according to claim 12 in which said base element is conventional baseboard product; and
said signage has safety content.
